(19) United States
(12) Patent Application Publication
(10) Pub. No.: US 2005/0149411 A1
(43) Pub. Date: Jul. 7, 2005

(54) System and method for creating individualized product and color palettes

(76) Inventor: Felton Thomas Colwell, Minnetonka, MN (US)

Correspondence Address: MERCHANT & GOULD PC, P.O. BOX 2903, MINNEAPOLIS, MN, 55402-0903, US

(21) Appl. No.: 10/988,174

(22) Filed: Nov. 12, 2004

Related U.S. Application Data
(60) Provisional application No. 60/519,218, filed on Nov. 11, 2003.

(51) Int. Cl. G06F 17/60

(52) U.S. Cl. 705/27

(57) ABSTRACT

A system and method for creating individualized color and product palettes for fabrication and sales of window coverings. The system includes a unique product palette processor interacting with a product palette database to specify requested goods in terms of a manufacturer product design palette when an order is created using a unique product palette created for and used by a single retailer or designer.

### CROSS-REFERENCE TO RELATED APPLICATION

This application claims the benefit of U.S. Provisional Application Ser. No. 60/519,218, filed on Nov. 11, 2003 entitled SYSTEM AND METHOD FOR CREATING INDIVIDUALIZED PRODUCT AND COLOR PALETTES. Such application is incorporated herein by reference.

### TECHNICAL FIELD

This application relates in general to a method and apparatus for creating individualized product palettes, and more particularly to a method and apparatus for creating individualized color and product palettes for fabrication and sales of window coverings.

### BACKGROUND

In many sales and manufacturing industries, retail sales entities (e.g., individuals, partnerships, corporations and other businesses entities having a physical presence) face significant competition from competitors that provide products over the Internet. In some of these industries, the retail entities also provide a service by assisting customers with the design, color, and/or selection of products to be purchased. More specifically with respect to the window coverings industry, the retail entities include interior designers, large retail chain companies, and smaller regional companies. Each of these retail entities offers virtually the same product(s) that emanate from a small number of manufacturers.

The retail entities offer varying amounts of assistance to customers in the design, color, and selection of the products. For window coverings, the products may be offered in a large number of colors, materials, and finishes, in addition to the size needed by the customer for a particular window. Therefore, many of the retail entities are able to distinguish themselves in the marketplace by offering additional design services to select a particular set of design characteristics for the products being purchased. Most of these additional services are offered by the retail entities at little or no cost to the customer as a means to generate sales opportunities. However, these retail entities have now discovered that these services, which generally include a design proposal for a particular set of products in a defined color, a specified material and a chosen finish, result in customers accepting for free the recommendations of the design help, but then purchasing the custom products from other retailers that sell the products at a lower price.

This shopping, sometimes referred to as “pirating”, of sales opportunities occurs in part because the recommendations for the custom designed goods are specified in terms of products from a particular manufacturer and having product characteristics specified in terms of that particular manufacturer's product design palette. Thus, a customer may take a recommended design for window coverings from the particular manufacturer to any number of other retailers and order the products. The end result of the customized product being specified in terms of the manufacturer's product design palette is that the product is reduced to a commodity item that may be purchased from any retailer at the lowest cost.

The above result introduces a significant cost to retail entities that provide design services to customers in the form of lost sales opportunities. If these same retail entities provided the specifications for the customized product in terms of a product design palette that did not equate to a manufacturer's product design palette, then it would be more difficult for potential customers to shop the customized product to other retailers. This would lead to the opportunity for more sales opportunities to be retained by the retail entities providing these additional and/or design services. Accordingly, there is a need for a system and method for creating individualized color and product palettes for selection, fabrication and sales of custom made products. These and numerous other disadvantages of the prior art necessitate the need for the method and apparatus provided by the present invention.

### SUMMARY

The present invention relates in general to a method and system for creating product palettes that do not equate to the manufacturer's product palettes. One preferred embodiment of the present invention is a system, method and apparatus for creating individualized product palettes. The system includes a unique product palette processor interacting with a product palette database to specify requested goods or customized products in terms of a manufacturer's product design palette when an order is entered/created using the individualized product palette.

The present invention may be utilized in connection with an entire manufacturer's product palette (e.g., the entire palette is transformed) or it may be employed with a subset of the manufacturer's product palette. In this latter example, designers can select specific products from the manufacturer's product palette with which they are comfortable and/or which describe in a sense their “taste” and/or style. The reduced number of options may also be selected and then identified with a disassociated brand name or origin. In this manner, it becomes more economically feasible and efficient to create small privately branded lines through sharing a manufacturer's inventory with other third parties.

Therefore according to one aspect of the invention, there is provided a system for creating individualized color palettes for fabrication and sales of window coverings, comprising: a palette database including a plurality of designated colors specified by a manufacturer and one or more unique colors associated with a respective designated color; a processor for identifying several unique colors and associating the identified colors with an individualized color palette; and a physical sample including the designated colors, wherein the physical sample identifies each of the designated colors by the corresponding unique color, whereby a unique color palette is created.

According to another aspect of the invention, there is provided, a method for creating individualized color palettes for use in generating customized color product orders, comprising: creating a table of one or more unique color names corresponding to a color name designated by a manufacturer; receiving orders including the unique color name; and translating the received order to an order having the color name designated by the manufacturer.

According to yet another aspect of the invention, there is provided a system for creating individualized color palettes for fabrication and sales of home products from a product palette of a manufacturer for third parties, the system comprising: a palette database including a plurality of designated colors specified by the manufacturer and a unique identifier for each designated color, wherein each unique identifier is associated with a third party; a processor for identifying the unique color identifiers and associating the identified unique color identifiers to a third party product palette; and a physical sample for each third party, the physical sample including the unique identifiers associated with the designated colors, wherein the physical sample identifies each of the designated colors by the corresponding unique color, and whereby the third party product palette is unique.

According to still another aspect of the invention, there is provided A method for generating and distributing unique aggregations of samples to individual designers, for use in generating customized color product orders, comprising: creating a table of one or more unique color names corresponding to a color name designated by a manufacturer; creating a physical sample utilizing the unique color names for each individual designer, wherein the physical sample identifies each of the products with the unique color names whereby each physical sample is unique; receiving orders including the unique color name; and translating the received order to an order having the color name designated by the manufacturer.

While the invention will be described with respect to preferred embodiment configurations and with respect to particular devices used therein, it will be understood that the invention is not to be construed as limited in any manner by either such configuration or components described herein. Also, while the particular types of window coverings are discussed as the customized products, it will be understood that customized products are not to be construed in a limiting manner. Instead, the principles of this invention extend to any environment in which customized products are ordered from a manufacturer's product design palette (and preferably where customized design services are created during the custom product sales transaction). These and other variations of the invention will become apparent to those skilled in the art upon a more detailed description of the invention.

The advantages and features which characterize the invention are pointed out with particularity in the claims annexed hereto and forming a part hereof. For a better understanding of the invention, however, reference should be had to the drawings which form a part hereof and to the accompanying descriptive matter, in which there is illustrated and described a preferred embodiment of the invention.

### BRIEF DESCRIPTION OF THE DRAWINGS

FIG. 1 illustrates an example embodiment of a system for creating individualized color and product palettes for fabrication and sales of window coverings according to one possible embodiment of the present invention.

FIG. 2 illustrates another example embodiment of a system for creating individualized color and product palettes for fabrication and sales of window coverings.

FIG. 3 illustrates a computing system that may be used to construct various computing systems that may be part of a distributed processing and communications system according to one embodiment of the present invention.

FIG. 4 functionally illustrates the blocks for creating individualized color and product palettes for fabrication and sales of window coverings according to one possible embodiment of the present invention.

FIG. 5 illustrates a product color palette transformation database according to an example embodiment of the present invention.

FIG. 6 illustrates a set of data processing modules used to implement a unique product palette processing module according to an example embodiment of the present invention.

FIG. 7 illustrates an example operation flow for a system for creating individualized color and product palettes for fabrication and sales of window coverings according to one possible embodiment of the present invention.

### DETAILED DESCRIPTION

This application relates in general to a method and apparatus for creating individualized color and product palettes for fabrication and sales of window coverings. In the following detailed description of exemplary embodiments of the invention, reference is made to the accompanying drawings, which form a part hereof, and in which is shown specific exemplary embodiments of the invention. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise. The term “connected” means a direct connection between the items connected, without any intermediate devices. The term “coupled” means either a direct connection between the items connected, or an indirect connection through one or more passive or active intermediary devices. The term “circuit” means either a single component or a multiplicity of components, either active and/or passive, that are coupled together to provide a desired function. The term “signal” means at least one current, voltage, or data signal. Referring to the drawings, like numbers indicate like parts throughout the views.

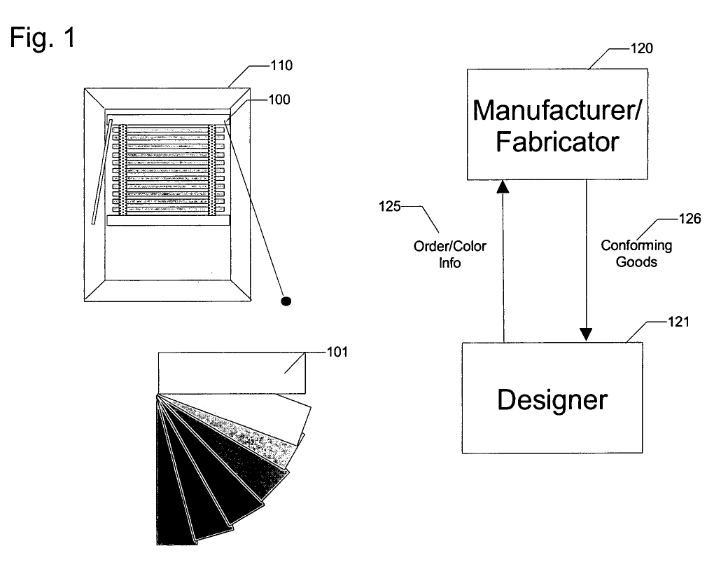

FIG. 1 illustrates an example embodiment of a system for creating individualized color and product palettes for fabrication and sales of window coverings according to one possible embodiment of the present invention. In a typical sale of a custom product, a designer/retailer 121 generates an order defining the custom goods 126 that are to be made for ultimate delivery to a customer. In a preferred embodiment, these goods consist of window coverings 100 that are custom made to fit into a particular window 110. In defining these window coverings 100, the designer 121 needs to specify design characteristics for the window coverings. These design characteristics usually begin with the size of the window 110 in which the product is to be installed. These design characteristics also include but are not limited to the color of the window coverings, the material to be used in the window coverings, and the finish for the materials used in construction of the goods 100.

These non-size design characteristics typically are obtained from a sample product palette 101 that the designer 121 uses when generating the order 125. The palette 101 illustrates the look, color and feel of the material used to make the window coverings 100. The designer often shows the palette 101 to customers to allow the selection of the design characteristics in light of the other items in the room containing the window 110 in which the window covering 100 is to be installed. Each item in the palette includes a name/ID that identifies the set of characteristics of choice. For example, the name/ID for a palette item may include a name “antique white” to describe the color of choice. The name/ID can also include an alpha-numeric code to allow the manufacturer 120 to identify the actual color in the color spectrum desired. Further, the name/ID can include an SKU code number (or an equivalent “model” number) that is unique to the manufacturer and which code identifies uniquely that product. Typically, although the “name” portion of the identifying information specifically identifies the color (or other aspect) of the product, the name portion itself is an arbitrary or descriptive term related to the color of the item. For example, there is a technical way in which colors can be identified. However, the “name” in this case is typically used as part of the marketing of the product(s) having a particular color from that manufacturer. The “name” generally is not the generic name for the particular/actual color.

Because of the relatively arbitrary nature of the name/ID used to identify the product palette item, a name/ID label unique to a particular designer for a particular set of design characteristics may be used in place of the name/ID label used by a manufacturer so long as the relationship between the designer's unique name/ID and the manufacturer's name/ID is known when generating and processing the order 125 to manufacture the conforming goods 126 to be delivered to a customer. The use of the designer's unique name/ID for the palette item will prevent, or at least increase the difficulty of, a customer taking a recommendation for a custom window covering to a different retailer to obtain the identical goods without the designer receiving economic benefit for generating the sale of the custom goods made by a particular manufacturer.

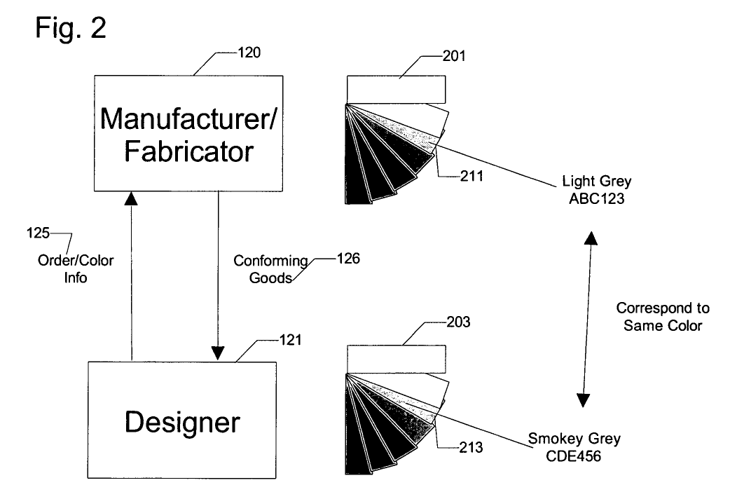

FIG. 2 illustrates another example embodiment of a system for creating individualized color and product palettes for fabrication and sales of window coverings according to one possible embodiment of the present invention. In this example embodiment, the same order 125 and delivery of conforming goods 126 are processed as discussed above with respect to FIG. 1. In this particular example, the palette item 213 selected by a customer corresponds to a grey color that possesses a name/ID label of Smokey Grey CDE456. The customer is shown the designer palette 203 that contains the selected palette item 213 and it is identified by the designer 121 as Smokey Grey CDE456.

Palette item 213 is, however, identified by a different name/ID within the manufacturer's palette 201. The manufacturer 120 calls this same color “Light Grey ABC123” (e.g., instead of the designation “Smokey Grey CDE456” used by the designer 121) even though the color is identical when the color is scientifically measured using a spectrometer. While the above example refers only to color, one skilled in the art will recognize that the same renaming of name/ID for design characteristics may also be performed for any other design characteristic without deviating from the spirit and scope of the present invention. It should also be appreciated that such identifiers and numbers are used by way of example, and are not intended to identify any designer's 121 and/or manufacturer's 120 actual particular identifier and number.

If a each designer/retailer possessed its own unique product palette 203 and a key to translate its palette item name/IDs into the corresponding palette name/IDs on the manufacturer's palette 201, then customers would be prevented from shopping a design to a number of retailers since the name/ID Smokey Grey CDE456 would have no meaning except to the designer 121 with whom the customer obtained the design. In such an environment, the manufacturer 120 would still make and sell the same products. However, the designer(s) 121 would not lose sales to other members of the retail distribution chain. Manufacturers 120 may also benefit from such a system in that the designer/retailers are more likely to suggest items made from a unique color palette that corresponds to a particular manufacturer palette rather than a color palette that permits the recommended design to be shopped to other retail providers. Loyalty of retailers to manufacturers would thereby be improved.

Such a system includes the generation of each unique product palette as well as a corresponding key to translate the name/ID from the unique palette to the product palette used by the manufacturer responsible for creating the custom goods. This key may consist of a simple hardcopy table of corresponding name/ID pairs that are provided to the designer for use in generating an order. This key may also be part of a software program that looks up the name/ID pair from a database of entries. This software program may be executed on a computing system local to the designer. Alternatively, this software program may be resident upon a server accessible over the Internet. This choice of which type of key mechanism is used may depend upon the number of entries in the product palette used by a designer, the need and desire for electronically transmitting the orders from the designer to the manufacturer, and the need for a manufacturer to know the name/ID pair from the designer's unique palette to label the goods in a name/ID reference that would be known to the end customer.

Finally, the remote use of the key to perform the translation of name/ID pairs would provide a mechanism for a customer to obtain a replacement item that was described to the customer in the unique palette name/ID when the designer in question is no longer available because he/she has gone out of business. In such a case, a customer may wish to contact a central entity that has access to the database of keys to determine how a replacement item may be obtained. The central entity may determine if the designer is still in business and/or still doing business with the central entity, and if so, refer the customer back to the designer for the replacement items. If the designer is not in business and/or is otherwise unable to provide the necessary products, then the customer may be referred to any other designer/retailer with the information necessary to permit the replacement item to be created and sold.

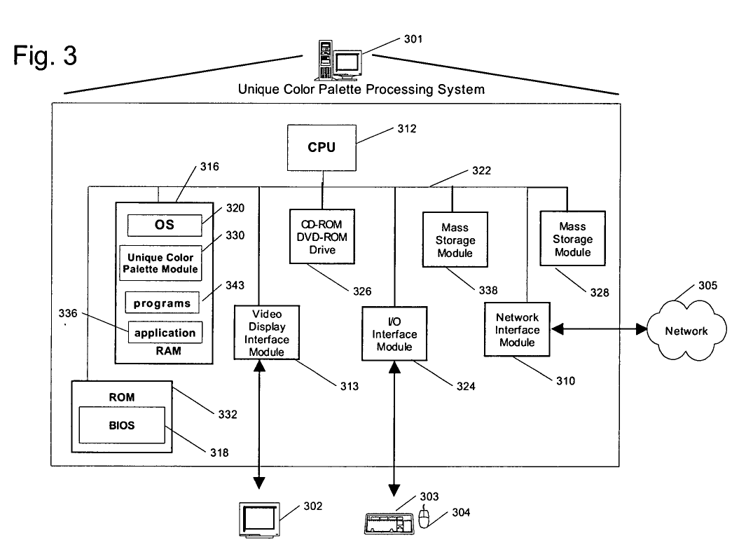

FIG. 3 illustrates a system that may be employed as a distributed processing and communications system according to one embodiment of the present invention. In an exemplary embodiment of a processing system 301, computing system 301 is operative to provide a unique product palette processing system, apparatus and method. Those of ordinary skill in the art will appreciate that the unique product palette processing system 301 may include many more components than those shown with reference to a computing system 301 shown in FIG. 3. However, the components shown are sufficient to disclose an illustrative embodiment for practicing the present invention. Those of ordinary skill in the art will appreciate that a network interface unit 310 includes the necessary circuitry for connecting unique product palette processing system 301 to a network of other computing systems 305, such as the internet, and is constructed for use with various communication protocols including the TCP/IP protocol. Typically, network interface unit 310 includes an Ethernet card, or the like.

Unique product palette processing system 301 also includes processing unit 312, video display adapter 313, and a mass memory 316, all connected via bus 322. The mass memory generally includes RAM 316, ROM 332, and one or more permanent mass storage devices, such as hard disk drive 328, a tape drive 338, CD-ROM/DVD-ROM drive 326, and/or a floppy disk drive (not shown). The RAM mass memory block 316 stores operating system 320 for controlling the operation of unique product palette processing system 301. It will be appreciated that this component may comprise a general purpose server operating system as is known to those of ordinary skill in the art, such as UNIX, MAC OS™, LINUX™, or Microsoft WINDOWS NT®. Basic input/output system (“BIOS”)318 is stored in ROM memory block 332 for controlling the low-level operation of processing system 301.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. More specifically, the mass memory stores applications including the unique product palette codes, names, etc., programs 343, and similar data processing applications 336. Application program 330 includes computer executable instructions which, when executed by computer 301, perform the logic described herein.

Unique product palette processing system 301 also comprises input/output interface 324 for communicating with external devices, such as a mouse 304, keyboard 303, scanner, or other input devices not shown in FIG. 3. Hard disk drive 328 may be utilized to by the unique product palette processing system 301 to store, among other things, application programs, databases, and program data. Such programs may be transferred via bus 322 to the memory module 316 to be subsequently acted on by processor 312. A video display unit 302 is operatively connected to the video display interface module 313 to provide the visually perceptive indicia to a user on the operation and status of the system 301.

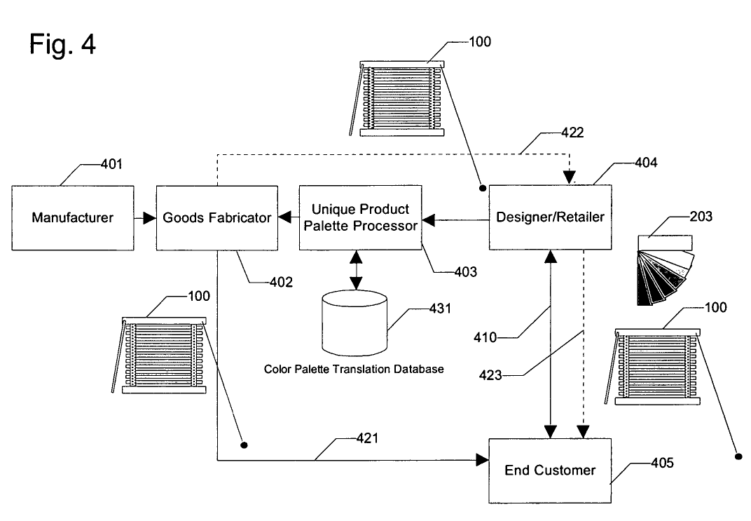

FIG. 4 illustrates an example embodiment of a system for creating individualized color and product palettes for fabrication and sales of window coverings in accordance with the principles of the invention. In this embodiment, the customer 405 interacts with a retailer/designer 404 to generate an order 410 as discussed above. The order 410 is prepared using a unique product palette 203 that has been created for use by only this particular retailer/designer 404. The retailer 404 submits the order to a unique product palette process 403 that translates the order into an order that may be sent to a fabricator 402 to generate the conforming goods 100. The unique product palette processor 403 uses a palette translation database 431 to match the name/ID listed in the incoming order with the corresponding name/ID in the product palette used by a fabricator 402. In this embodiment, the fabricator 402 may be a separate entity from the manufacturer 401 of the goods. Particularly in the window coverings industry, manufacturers 401 often produce the components that are then assembled by fabricators 402. In this particular arrangement, the common product palette corresponds to the color, material and finish characteristics of the components made by the manufacturer 401. The fabricator uses the product palette for the manufacturer because these product characteristics correspond to the components rather than the assembled item.

The conforming goods 100, when completed by a fabricator, may be sent to the customer 405 directly 421 (e.g., a drop-ship type of arrangement). Optionally, the conforming goods 100 may be sent to the retailer 404 (see designation 422) for ultimate delivery 423 to the customer 402. As discussed above, the conforming goods 100 may be labeled or marked as conforming to the name of the design characteristics from the retailer palette 203 rather than the manufacturer palette 201. In addition to being utilized in connection with the manufacture and sale of window coverings, one skilled in the art will recognize that other products (e.g., such as floor coverings and wall coverings) that can be defined in terms of design palette characteristics may also be used without deviating from the spirit and scope of the present invention.

In addition, the use of a product palette processor may be used at any number of levels in the product distribution chain. If several distributors, for example, received goods from a single fabricator in response to orders received from retailers and then the distributors passed the goods back to the retailers, then use of such a processor 403 together with a unique palette for each distributor would prevent the shopping of orders by retailers to different distributors. Similarly, if multiple fabricators existed and received orders from numerous distributors and/or retailers, a unique product palette for a fabricator would prevent these distributors and retailers from shopping the orders among fabricators.

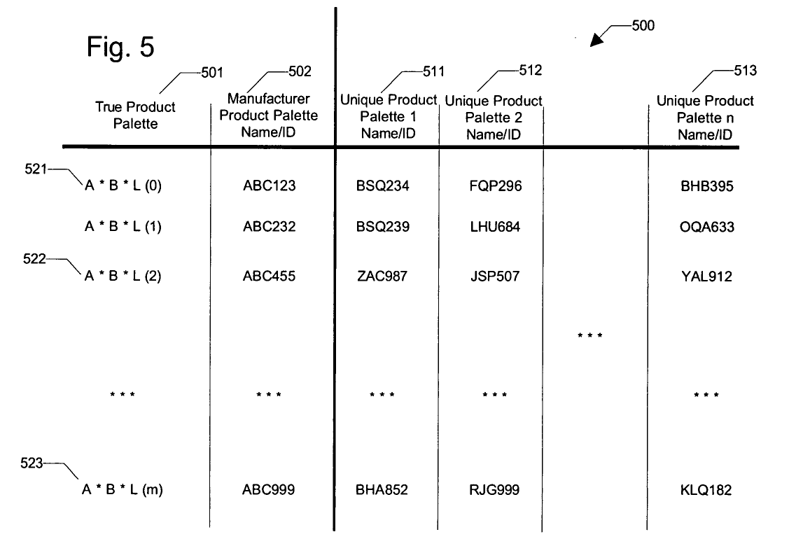

FIG. 5 illustrates a product color palette transformation database according to an example embodiment of the present invention. For each entry in the database table 500, an entry corresponding to the true product palette description 501 for a design characteristic is needed. In the example of FIG. 5, the design characteristic corresponds to product color and the color is expressed in terms of is color attributes as measured by a spectrometer. This color attribute may be specified in any number of means that are used to uniquely identify a product color such that any one skilled in the art will be able to accurately reproduce the color specified. It will also be appreciated that the scientific designation or true color palette may not be required. Instead, each of the individual product palettes may be related to a single corresponding entry in the manufacturer's palette.

The entry in the database table also includes an entry for the ID used by the manufacturer 502 to define the palette entry. In this example, only an alpha-numeric code is shown. One skilled in the art will recognize that a descriptive name and/or an alpha-numeric ID may be used without deviating from the spirit and scope of the present invention. The remaining portion of the database includes a column in the database table 500 for each of the unique product palettes 511-513 that have been generated for each of the retailers using the system. The unique product palette processor 403 uses this table as a key to look up the matching name/ID received to describe an order and then translates the name/ID to the corresponding name/ID in the manufacturer palette 502 in order to obtain goods having a desired color. This process operates in the exact same manner for any number of other design characteristics such as material and finish as discussed above.

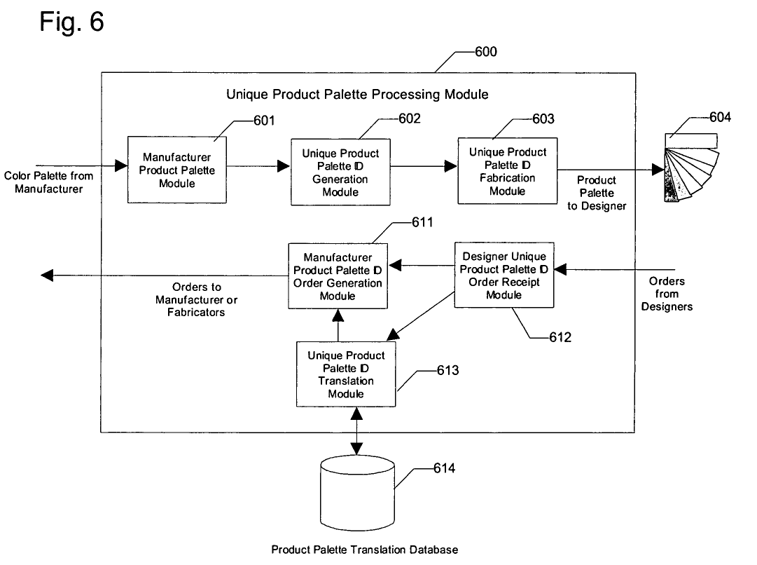

FIG. 6 illustrates a set of data processing modules used to implement a unique product palette processing module according to an example embodiment of the present invention. Within the unique product palette processor 301, a set of data processing modules may be used to obtain the process described above. In a first portion of the processor 600, the set of unique product palette entries are generated. In this portion of the system, the product palette is received from the manufacturer in a manufacturer product palette module 601. This module 601 will identify and characterize the entries within the manufacturer product palette. This data is then passed to a unique product palette ID generation module 602. This module 602 generates the unique name/IDs needed for each entry in the manufacturer palette for each unique palette needed by retailers and designers. This module 602 also enters all of this data into the database table 500 within the product palette translation database 614. A unique product palette ID fabrication module 603 is then used to generate any physical palette items used by retailers to show customers the design characteristics of the products offered to sale. These physical palette items may be marked with the name/ID from the unique retailer palette for use when creating an order for a customer.

The second part of the process occurs when an order is being processed for a customer. The order is received from a designer by a designer unique product palette order receipt module 612. This module interacts with a unique product palette translation module 613 to verify that a proper translation is possible. The module 612 also passes the order to a manufacturer product palette ID order generation module 611 for creation of the order that is sent to a manufacturer for fabrication. The module 613 also translates the manufacturer name/ID from the database 614 given the designer unique product palette name/ID. The appropriate manufacturer name/ID is then passed to module 611 for generating the order for the manufacturer. Alternatively, the designer may also be provided with the key or translation of the unique product palette name/ID to the manufacturer name/ID. This key may be provided in a paper format, a computer readable medium (e.g., CD or floppy disk), or via an internet look-up directory (e.g., with a password provided only to the particular designer).

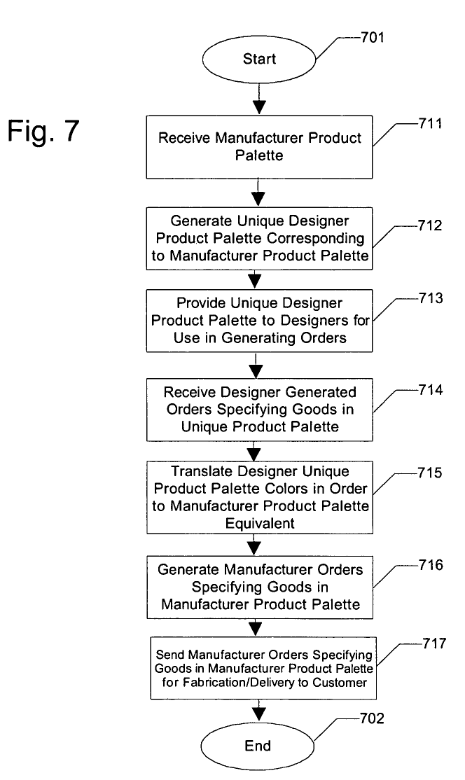

FIG. 7 illustrates an example operation flow for a system for creating individualized color and product palettes for fabrication and sales of window coverings according to one possible embodiment of the present invention. The process starts at 701 and module 711 receives a manufacturer product palette and characterizes it for generation of a unique designer product palette at module 712. Once the unique palette has been generated, it is used to generate orders by a designer that is received at module 714. These orders specify the requested goods in terms of the product palette descriptions contained in the unique palette.

The received order is processed in module 715 to translate the product palette description name/ID to the product palette used by the manufacturer to make the goods. The translated information is used in module 716 to generate an order that is to be sent to the manufacturer. The manufacturer uses this translated order to make the conforming goods 717 for ultimate shipment to the end customer. Receipt of the conforming goods by the customer ends the process at 702.

As noted above, the present invention may be utilized in connection with an entire manufacturer's product palette 201 (e.g., the entire palette is transformed) or it may be employed with a subset of the manufacturer's product palette 201. In this latter example, designers can select specific products from the manufacturer's product palette 201 with which they are comfortable and/or which describe in a sense their “taste” and/or style. This results in an aggregation of samples, styles and colors in the selected palette. The palette may also be comprised of manufacturer's suggested colors, etc. based on a designer determining that they would like a certain style (e.g., “contemporary” or “traditional”). The reduced number of options may also be selected and then identified with a disassociated brand name. In this manner, it becomes more economically feasible and efficient to create relatively smaller or small privately branded lines through the sharing of a manufacturer's inventory with other third parties. Further, by changing the “name” of the product, a protection is afforded without actually changing the product.

Turning again to FIG. 2, selection and/or other elimination of certain products from the manufacturer's product palette 201 results in a reduced, stylized designer palette 203. By way of example, a series of predominantly red, white and blue colors might be selected and identified as the “Betsy Ross” or “George Washington” Collection. Alternatively, a living individual (e.g., a race car driver; stage, screen or television personality; athlete; politician or other personality) and/or entity (e.g., professional sports team, television show, etc.) may lend its name to a collection of colors/styles in the reduced set. In this manner, a disassociated brand name is created for marketing of the product palette 203.

FIG. 3 illustrates an example of a suitable operating environment in which the invention may be implemented. The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Additionally, the embodiments described herein are implemented as logical operations performed by a programmable processing device. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

While the above embodiments of the present invention describe a system and method for creating individualized color and product palettes for fabrication and sales of window coverings, one skilled in the art will recognize that the use of a particular computing architecture for a data processing system are merely example embodiments of the present invention. It is to be understood that other embodiments may be utilized and operational changes may be made without departing from the scope of the present invention as recited in the attached claims.

As such, the foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. The present invention is presently embodied as a method and apparatus for generating an electronic model for creating individualized color and product palettes for fabrication and sales of window coverings.

1. A system for creating individualized color palettes for fabrication and sales of window coverings, comprising:
a) a palette database including a plurality of designated colors specified by a manufacturer and one or more unique colors associated with a respective designated color;
b) a processor for identifying several unique colors and associating the identified colors with an individualized color palette; and
c) a physical sample including the designated colors, wherein the physical sample identifies each of the designated colors by the corresponding unique color, whereby a unique color palette is created.

2. The system of claim 1, wherein the processor receives orders including the unique color information.

3. The system of claim 2, wherein the processor translates the unique color information from the palette database into the designated color.

4. The system of claim 3, wherein the processor forwards the order having the designated color information to the manufacturer.

5. A method for creating individualized color palettes for use in generating customized color product orders, comprising:
a) creating a table of one or more unique color names corresponding to a color name designated by a manufacturer;
b) receiving orders including the unique color name; and
c) translating the received order to an order having the color name designated by the manufacturer.

6. The method of claim 5, further comprising the step of forwarding the order to a manufacturer.

7. The method of claim 5, wherein the table is a look-up table in a computer database.

8. The method of claim 5, wherein the orders are received from the internet.

9. The method of claim 5, wherein the table includes a plurality of unique color names corresponding to each color name designated by a manufacturer.

10. A system for creating individualized color palettes for fabrication and sales of home products from a product palette of a manufacturer for third parties, the system comprising:
a) a palette database including a plurality of designated colors specified by the manufacturer and a unique identifier for each designated color, wherein each unique identifier is associated with a third party;
b) a processor for identifying the unique color identifiers and associating the identified unique color identifiers to a third party product palette; and
c) a physical sample for each third party, the physical sample including the unique identifiers associated with the designated colors, wherein the physical sample identifies each of the designated colors by the corresponding unique color, and whereby the third party product palette is unique.

11. The system of claim 10, wherein the processor receives orders including the unique color information.

12. The system of claim 11, wherein the processor translates the unique color information from the palette database into the designated color.

13. The system of claim 12, wherein the processor forwards the order having the designated color information to the manufacturer.

14. The system of claim 10, wherein the third party product palette includes fewer products than the plurality of designated colors in the palette database.

15. The system of claim 10, wherein the third party product palette includes each of the plurality of designated colors in the palette database.

16. A method for generating and distributing unique aggregations of samples to individual designers, for use in generating customized color product orders, comprising:
a) creating a table of one or more unique color names corresponding to a color name designated by a manufacturer;
b) creating a physical sample utilizing the unique color names for each individual designer, wherein the physical sample identifies each of the products with the unique color names whereby each physical sample is unique;
c) receiving orders including the unique color name; and
d) translating the received order to an order having the color name designated by the manufacturer.

17. The method of claim 16, further comprising the step of forwarding the order to a manufacturer.

18. The method of claim 16, wherein the table is a look-up table in a computer database.

19. The method of claim 16, wherein the samples are decorating samples.

20. The method of claim 16, wherein the table includes a plurality of unique color names corresponding to each color name designated by a manufacturer.
